(19) United States
(12) Patent Application Publication
(10) Pub. No.: US 2006/0180619 A1
(43) Pub. Date: Aug. 17, 2006

(54) Security system for backpack or luggage bag

(76) Inventor: MRM Holdings Limited, Hong Kong (HK)

Correspondence Address: MRM HOLDINGS LIMITED, GPO BOX 11464, HONG KONG, HK

(21) Appl. No.: 11/337,839

(22) Filed: May 1, 2006

(30) Foreign Application Priority Data
Jan. 14, 2005 (AU) 2005900250

(51) Int. Cl. E05B 73/00; A63B 57/00

(52) U.S. Cl. 224/191; 70/18

(57) ABSTRACT

A security system for a backpack or luggage bag having an exterior fabric layer comprises a wire mesh structure and a layer of protective material located between the wire mesh structure and the exterior fabric layer of the backpack or luggage bag.

### BACKGROUND TO THE INVENTION

1. Field of the Invention

The invention relates to a security system for a backpack or luggage bag.

2. Background Information

The present applicant has proposed a security device for a backpack or luggage bag comprising a cover in the form of a wire mesh structure that is held snugly to the backpack by a draw line. The draw line is tightened and locked tight with a locking mechanism. The cover prevents tampering with or removing the backpack from the wearer, and especially the slicing open of backpack to remove its contents. The present applicant has also proposed a backpack or luggage bag incorporating a similar wire mesh structure laminated between a lining of the bag and the bag exterior. Any attempt to sever the bag is foiled as a knife blade engages the wire mesh structure. The proposed security device and Security Luggage bag are described in the published patent documents U.S. Pat. No. 6,244,081, U.S. Pat. No. 6,026,662, EP0878143, EP0878143, AU0695896, AU0678697, US20030110818A1 and AU20020247, the contents of which are incorporated herein by reference.

A disadvantage with the above proposals is that the wire mesh structure causes point wearing of the luggage bag fabric.

### OBJECT OF THE INVENTION

It is an object of the present invention to provide a security system for a backpack or luggage bag that overcomes or ameliorates the above problem of at least provides the public with a useful alternative.

### SUMMARY OF THE INVENTION

According to the present invention there is provided a security system for a backpack or luggage bag having an exterior fabric layer, comprising a wire mesh structure and a layer of protective material located between the wire mesh structure and the exterior fabric layer of the backpack or luggage bag.

Preferably, the backpack or luggage bag also has an interior fabric layer, the protective material comprising an inner fabric layer located between the interior and exterior fabric layers and wherein the wire mesh structure is laminated between the interior fabric layer and the inner fabric layer of the backpack or luggage bag.

Preferably, the inner fabric layer comprises a fabric mesh.

Preferably, the backpack or luggage bag also has an additional layer of material between the inner fabric layer and the exterior fabric layer.

Preferably, the additional layer of material comprises a polypropylene sheet.

Preferably, the protective material comprises a resilient coating covering the wire mesh structure.

Preferably, the resilient coating is plastic.

Preferably, the resilient coating is applied to cover the wire mesh structure using a fluidized-bed process.

Preferably, the backpack or luggage bag also has an interior fabric layer and the coated wire mesh structure is located between the interior fabric layer and exterior fabric layer of the backpack or luggage bag.

Preferably, the wire mesh structure comprises netting adapted to be held snugly to the exterior fabric of the backpack or luggage bag by a draw line tightened and locked with a locking mechanism

Further aspects of the current invention will become apparent from the following description which is given by way of example only.

### BRIEF DESCRIPTION OF THE DRAWINGS

A security luggage bag according to the invention will now be described by way of example only with reference to the accompanying drawings in which:

FIG. 1 illustrates a first embodiment of the invention, and

FIG. 2 illustrates a second embodiment of the invention.

### DETAILED DESCRIPTION OF THE INVENTION

In a preferred embodiment of the invention a security backpack or luggage bag (not shown) has an exterior fabric layer 1, an interior fabric layer 2 and a wire mesh structure 3 located between the interior fabric layer 2 and exterior fabric layer 1 of the backpack or luggage bag to prevent the slicing open of the backpack or luggage bag to remove its contents. The wire mesh 3 structure is joined at various points with clips 6.

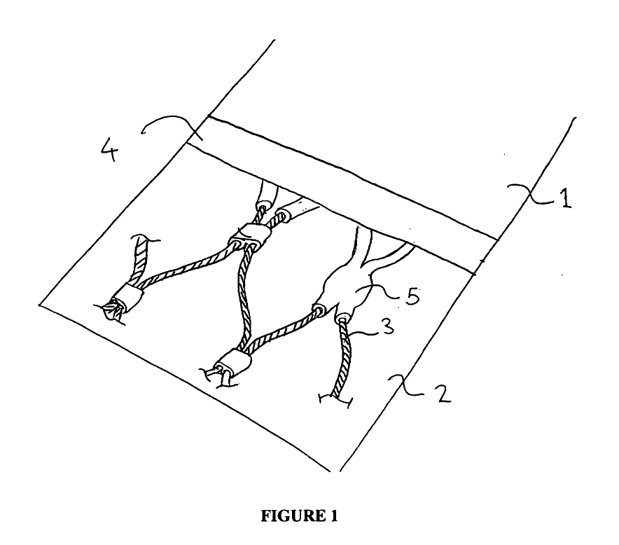

In FIG. 1 there is shown a layer of protective material comprising an inner fabric layer 4 located between the wire mesh structure 3 and the exterior fabric layer 1 of the backpack to reduce point wearing of the exterior fabric layer 1, particularly in the area of clips 6. The wire mesh structure 3 is laminated in known manner between the interior fabric layer 2 and inner fabric layer 4 of the backpack or luggage bag.

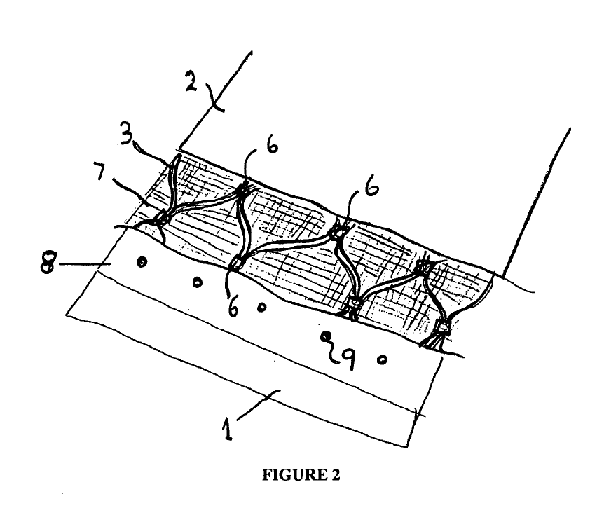

In an alternative embodiment shown in FIG. 2 the inner layer is a fabric mesh 7. The wire mesh structure 3 is laminated in known manner between the interior fabric layer 2 and fabric mesh layer 7 of the backpack or luggage bag. Additionally a layer of 0.4 mm thick Polypropylene (PP) sheet is placed between the fabric mesh layer 7 and exterior fabric layer 1. The 0.4 mm PP sheet spreads the high points created by the mesh clips 6 over a greater area to further reduce point wearing of the exterior fabric layer 1.

The 0.4 mm PP sheet is provided with a plurality of small (1 mm-2 mm diameter) holes 9. The inventor has found that any water entering the backpack or bag through stitching will follow a path along the wire mesh 3 through the bag walls. The fabric mesh layer 7 and holes 9 in the PP sheet allow the water to drain away from the interior of the bag. Additional small hopes can be made at locations in the exterior fabric layer 1 so that the water can exit the bag walls.

Alternatively or additionally the wire mesh structure 3 can be completely or partially covered with a layer of plastic or other resilient material 6 using a fluidised-bed process. Coating wire structures in this way using a fluidised-bed process is well-known and need not be described in further detail. The plastic or other resilient coating 5 provides another protective layer between the wire mesh structure 3 and the exterior fabric layer 1 of the backpack or luggage bag.

In an alternative embodiment of the invention the coated wire mesh structure comprises netting adapted to be held snugly to the exterior fabric of the backpack or luggage bag by a draw line tightened and locked with a locking mechanism as depicted and described in U.S. Pat. No. 6,244,081, U.S. Pat. No. 6,026,662, EP0878143, EP0878143, AU0695896 and AU0678697.

Embodiments of the invention comprise a layer of protective material located between the wire mesh structure 3 and the exterior fabric layer 1 of the backpack or luggage bag. The protective layer may be either or both of an inner fabric layer 4 of the bag and/or a resilient coating 5 covering all or part of the wire mesh structure 3.

Where in the foregoing description reference has been made to integers or elements having known equivalents then such are included as if individually set forth herein.

Embodiments of the invention have been described, however it is understood that variations, improvement or modifications can take place without departure from the spirit of the invention or scope of the appended claims.

What is claimed is:

1. A security system for a backpack or luggage bag having an exterior fabric layer, comprising a wire mesh structure and a layer of protective material located between the wire mesh structure and the exterior fabric layer of the backpack or luggage bag.

2. The system of claim 1 wherein the backpack or luggage bag also has an interior fabric layer, the protective material comprising an inner fabric layer located between the interior and exterior fabric layers and wherein the wire mesh structure is laminated between the interior fabric layer and the inner fabric layer of the backpack or luggage bag.

3. The system of claim 2 wherein the inner fabric layer comprises a fabric mesh.

4. The system of claim 2 further including an additional layer of material between the inner fabric layer and the exterior fabric layer.

5. The system of claim 4 wherein the additional layer of material comprises a polypropylene sheet.

6. The system of claim 1 wherein the protective material includes a resilient coating covering the wire mesh structure.

7. The system of claim 6 wherein the resilient coating is plastic.

8. The system of claim 6 wherein the resilient coating is applied to cover the wire mesh structure using a fluidized-bed process.

9. The system of claim 6 wherein the backpack or luggage bag also has an interior fabric layer and the coated wire mesh structure is located between the interior fabric layer and exterior fabric layer of the backpack or luggage bag.

10. The system of claim 6 wherein the wire mesh structure comprises netting adapted to be held snugly to the exterior fabric of the backpack or luggage bag by a draw line tightened and locked with a locking mechanism.
